(19) United States
(12) Patent Application Publication
(10) Pub. No.: US 2024/0412206 A1
(43) Pub. Date: Dec. 12, 2024

(54) DATA RETRIEVAL THRESHOLDS FOR TRANSACTION ANALYSIS

(71) Applicant: Truist Bank, Charlotte, NC (US)

(72) Inventors: Jonathan Topp, Montpelier, VA (US); Priya Kenkare Shankaranarayana, Sandy Springs, GA (US); Heather Choudhury, Stone Mountain, GA (US); Michael Geist, Woodstock, GA (US); Veeranjaneya Chandu, Alpharetta, GA (US)

(73) Assignee: Truist Bank, Charlotte, NC (US)

(21) Appl. No.: 18/330,814

(22) Filed: Jun. 7, 2023

(51) Int. Cl. G06Q 20/38; G06Q 20/42

(52) U.S. Cl. CPC G06Q 20/389; G06Q 20/42

(57) ABSTRACT

A computer-implemented method includes receiving parameters including an account threshold. The account threshold can define a maximum number of accounts that can be included in a request. The method also includes executing an application programming interface call associated with the request to an interaction channel based on the at least one parameter. The method further includes receiving data that satisfies the parameters in response to the application programming interface call. Additionally, the method includes causing a display of the data at a user interface of a client device. The data can be used by the client device to analyze account activity.

### TECHNICAL FIELD

The present disclosure relates generally to providing transaction information and, more particularly (although not necessarily exclusively), to data retrieval thresholds to facilitate transaction analysis.

### BACKGROUND

Users may initiate transactions of resources using transaction systems. The transaction system may predict future transactions and amounts of resources available to the user for the transactions. The resources associated with the expected transactions can be obtained using various channels such as via online deposits channels, wire transfer channels, and other electronic resource transfer channels. Thus, the transaction system may provide insight into expected transactions for various channels.

### SUMMARY

In one example, a system includes a processing device and a memory device that includes instructions that are executable by the processing device to cause the processing device to perform operations. The operations include receiving, by a multi-channel adapter, at least one parameter including an account threshold defining a maximum number of accounts includable in a request. The operations also include executing, by the multi-channel adapter, at least one application programming interface call associated with the request to at least one interaction channel based on the at least one parameter. Additionally, the operations include receiving, by the multi-channel adapter, data that satisfies the at least one parameter in response to the at least one application programming interface call. The operations further include causing, by the multi-channel adapter, a display of the data at a user interface of a client device, the data usable by the client device to analyze account activity.

In another example, a computer-implemented method includes receiving, by a multi-channel adapter, at least one parameter including an account threshold defining a maximum number of accounts includable in a request. The method also includes executing, by the multi-channel adapter, at least one application programming interface call associated with the request to at least one interaction channel based on the at least one parameter. Additionally, the method includes receiving, by the multi-channel adapter, data that satisfies the at least one parameter in response to the at least one application programming interface call. The method further includes causing, by the multi-channel adapter, a display of the data at a user interface of a client device, the data usable by the client device to analyze account activity.

In another example, a non-transitory computer-readable medium includes instructions that are executable by a processing device for performing operations. The operations include receiving, by a multi-channel adapter, at least one parameter including an account threshold defining a maximum number of accounts includable in a request. The operations also include executing, by the multi-channel adapter, at least one application programming interface call associated with the request to at least one interaction channel based on the at least one parameter. Additionally, the operations include receiving, by the multi-channel adapter, data that satisfies the at least one parameter in response to the at least one application programming interface call. The operations further include causing, by the multi-channel adapter, a display of the data at a user interface of a client device, the data usable by the client device to analyze account activity.

### BRIEF DESCRIPTION OF THE DRAWINGS

FIG. 1 is a block diagram of an example of a system for facilitating transaction analysis using data retrieval thresholds according to one example of the present disclosure.

FIG. 2 is an example of a user interface for providing parameters to facilitate transaction analysis according to one example of the present disclosure.

FIG. 3 is an example of a user interface for facilitating transaction analysis using data retrieval thresholds according to one example of the present disclosure.

FIG. 4 is a block diagram of an example of a computing system for facilitating transaction analysis using data retrieval thresholds according to one example of the present disclosure.

FIG. 5 is a flowchart of process for facilitating transaction analysis using data retrieval thresholds according to one example of the present disclosure.

### DETAILED DESCRIPTION

Certain aspects and examples of the present disclosure relate to a system and method for facilitating transaction analysis using data retrieval thresholds. The system can generate a real-time connection with various interaction channels and selectively retrieve data from the interaction channels. The system may selectively retrieve the data based on parameters that can be tailored to provide seamless communication with the interaction channels and further tailored based on client preferences. The parameters may include the data retrieval thresholds, which can be unique for each of the interaction channels. The system may receive the data retrieval thresholds from the interaction channels. The data retrieval thresholds can maximize processing speed of data by permitting the system to retrieve a particular amount of data with a request. The particular amount of data can be a maximum amount of data that can be retrieved from an interaction channel with a request without causing latency, or without causing an increase in latency above a threshold, for data processing within the interaction channel. By way of one example, the system can, in response to a request from a client device, automatically execute an application programming interface (API) call to retrieve data for a number of input parameters, where the number of input parameters are equal to or less than a data retrieval threshold for an interaction channel. Certain examples provide a multi-channel adapter that can increase processing speed of data from the interaction channels by selectively retrieving the data in accordance with the data retrieval thresholds.

In some examples, the interaction channels can be transaction channels containing transaction data. Examples of transaction channels may include Automated Clearing House (ACH), Online Deposit, Wire Transfer, Lockbox, Remote Deposit Capture, etc. Additionally, the transaction data can include, for example, an account number associated with a transaction, a number of resources associated with the transaction, a timestamp at which the transaction was initiated, or other suitable transaction data.

The multi-channel adapter can store parameters associated with the interaction channels, such as the data retrieval thresholds for each of the interaction channels. The data retrieval thresholds can be a maximum number of input parameters, such as demand deposit account (DDA) numbers, for which data can be retrieved via an API call transmitted by the multi-channel adapter. The multi-channel adapter may receive the data retrieval thresholds (e.g., the maximum number of input parameters) from a client device, from the interaction channels, or a combination thereof. For example, the multi-channel adapter may receive a maximum number of DDA numbers for which data can be requested. Thus, the multi-channel adapter can request data for up to the maximum number of DDA numbers. As a result, an amount of data retrieved from the interaction channels can depend on the maximum number of DDA numbers or other suitable maximum number of input parameters provided to the multi-channel adapter. In some examples, the client device can receive a data retrieval threshold from a user and can transmit the data retrieval threshold to the multi-channel adapter. Additionally, in some examples, the data retrieval thresholds can be account thresholds. An account threshold can be a maximum number of accounts for which data can be received for a request from the multi-channel adapter to an interaction channel. The account threshold or other suitable data retrieval thresholds can prevent excessive latency in the interaction channels, thereby improving processing time for requests for data from the interaction channels by the multi-channel adapter. Additionally, the data retrieval thresholds can minimize an impact of retrieving data from the interaction channels on the functioning of the interaction channels. For example, a function of an interaction channel can include processing transactions. By controlling the amount of data retrieved from the interaction channel via the data retrieval threshold, the retrieval of data may not interfere or cause latency for the function of the interaction channel.

The multi-channel adapter can further store parameters according to user preferences. The parameters associated with user preferences can be received by a client device from a user, and the client device can transmit the parameters to the multi-channel adapter. As an example, the user preferences can indicate a type of transaction data desired from each of the interaction channels. The type of transaction data can be unique for each interaction channel and each interaction channel can include various types of transaction data. For example, a first type of transaction data for wire transfers can be domestic wire transfers and a second type of transaction data for wire transfers can be international wire transfers. Additionally, for ACH a third type of transaction data can be for credit transactions and a fourth type of transaction data can be for debit transactions. Thus, the multi-channel adapter can transmit requests for data based on the parameters to facilitate selective and efficient transmission of the data to the client device. The multi-channel adapter can further facilitate analysis of the data at the client device by retrieving the data according to the user preferences.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

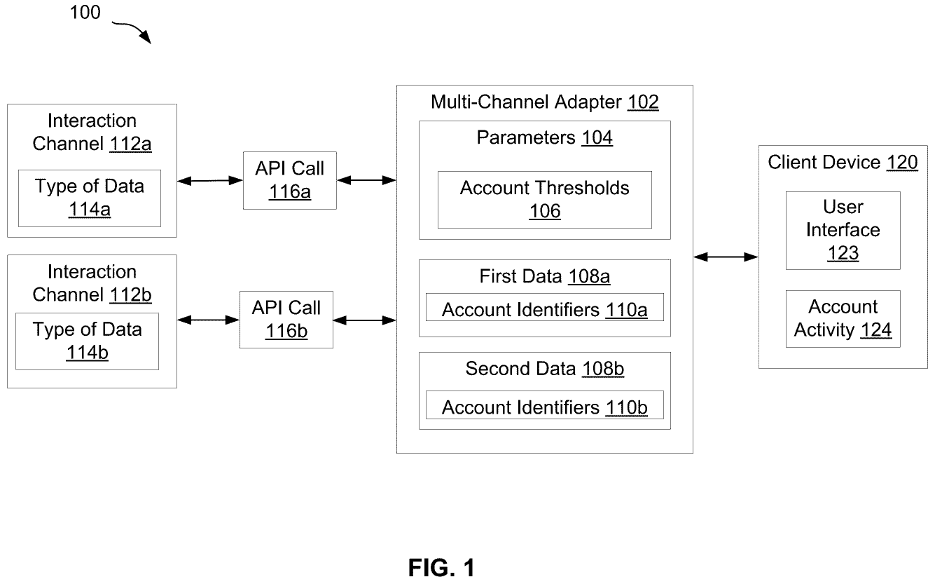

FIG. 1 is a block diagram of an example of a system 100 for facilitating transaction analysis using data retrieval thresholds according to one example of the present disclosure. The system 100 can include a multi-channel adapter 102 that can be communicatively coupled with a client device 120 and interaction channels 112a-b. In some examples, the interaction channels 112a-b can be transaction channels (e.g., payment systems or payment applications) that can be used to carry out transactions. Examples can include Automated Clearing House (ACH), Lockbox, Online Bill Consolidator, Remote Deposit, etc.

The system 100 may receive, by a multi-channel adapter 102, parameters 104, which can define data 108a-b requested by the client device 120 from the interaction channels 114. The parameters can include an account threshold 106, which can define a maximum number of accounts that can be included in a request from the interaction channels 112a-b by the multi-channel adapter 102. The account threshold 106 can be determined based on the maximum number of accounts for which the multi-channel adapter 102 can request data without causing latency in the interaction channels 112a-b. Thus, the account threshold 106 can improve processing time for the interaction channels 112a-b and for the multi-channel adapter retrieving data 108 from the interaction channels 112a-b. Additionally, the account threshold 106 can be received by the multi-channel adapter 102 from the client device 120 or the interaction channels 112a-b. In some examples, the client device 120 can receive account thresholds 106 from a user via a user interface 123 for each of the interaction channels and can transmit the account threshold 106 to the multi-channel adapter. The multi-channel adapter 102 can store the parameters 104, including the account thresholds 106, to facilitate continuous and selective retrieval of data from the interaction channels 112a-b.

In an example, a first interaction channel 112a can be associated with wire transfers and a second interaction channel 112b can be associated with ACH. The parameters for the first interaction channel 112a can include wire type codes, transaction type codes, and a first account threshold. The transaction type codes for the first interaction channel 116a can be types of wire transactions such as domestic wire transfers, international wire transfers, or other suitable wire transfers. The wire type codes can be codes to identify the accounts to which the wire transfers are being sent. The first account threshold can be a first number of accounts for which the multi-channel adapter 102 can request data without causing latency in the processing of wire transfers. For instance, the first account threshold may be five-hundred accounts. The parameters for the second interaction channel 112b can include transaction codes and a second account threshold. The transaction codes for the second interaction channel 112b can be types of ACH transactions such as debit transactions or credit transactions. The second account threshold can be a second number of accounts for which the multi-channel adapter 102 can request data without causing latency for ACH transactions. For instance, the second account threshold may be one-hundred accounts.

Additionally, the system 100 execute, by the multi-channel adapter 102, API calls 116a-b to the interaction channels 112a-b. The API calls 116a-b can be requests transmitted by the multi-channel adapter 102 to the interaction channels 112a-b. The API calls 116a-b can be unique for each interaction channel 112a-b and can be based on the parameters 104. For example, in response to a request from the client device 120, the multi-channel adapter 102 can execute a first API call 116a. The first API call 116a can be a request for a first type of data 114a based on the transaction type codes in the parameters 104 for the first interaction channel 112a. The first API call 116a can further include the wire type codes and the first API call 116a can request data for a number of accounts that is less than the first account threshold. Additionally, in response to the request, the multi-channel adapter 102 can execute a second API call 116b to the second interaction channel 112b. The second API call 116b can be a request for second type of data 114b based on the transaction codes for the second interaction channel 112b. The second API call 116b can further request data for a number of accounts that is less than the second account threshold.

Thus, the system 100 can receive, by the multi-channel adapter 102, the data 108a-b that satisfies the parameters 104 in response to the API calls 116a-b. In response to the first API call 116a, the multi-channel adapter 102 can receive first data 108a for a first set of account associated with account identifiers 110a. Additionally, in response the second API call 116b, the multi-channel adapter 102 can receive second data 108b for a second set of accounts associated with account identifiers 110b.

The multi-channel adapter 102 can transmit the data 108a-b to the client device 120 to cause display of the data 108a-b at the user interface 123 of the client device 122. The user interface 123 may include graphs, tables, or other suitable methods of organizing and displaying the data 108a-b. Additionally, the data 108a-b can be used by the client device 120 to analyze account activity 124. For example, the data 108a-b can be indicative of funds expected to be received by accounts 110a-b within a certain timeframe, such as one business day. Thus, the client device 120 can generate a prediction of upcoming account activity based on the subsets of data 108a-b. The data 108a-b can also be used to analyze account activity 124 such as transaction volume, processing time between initiation of a transaction and the transaction being received at an account, or other suitable account activity.

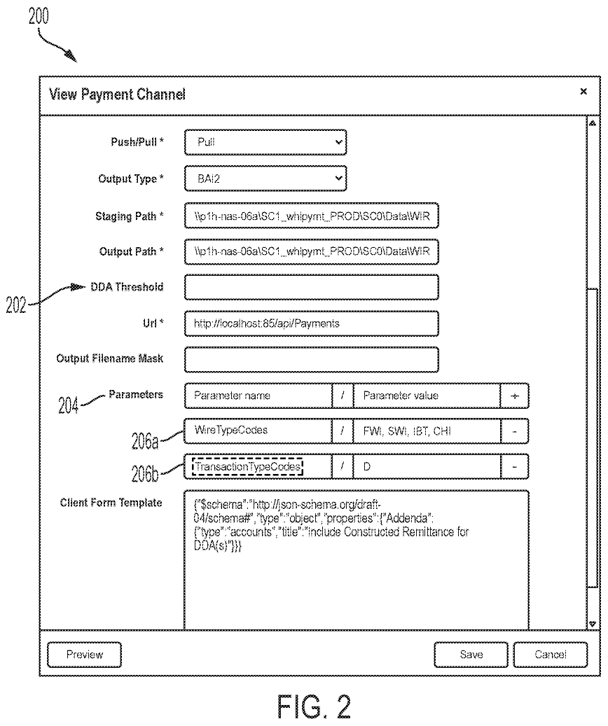

FIG. 2 is an example of a user interface 200 for providing parameters 204 to facilitate transaction analysis according to one example of the present disclosure. Aspects of FIG. 2 are discussed in reference to the components shown in FIG. 1. The user interface 200 can be a display on a client device 120 such as a laptop, tablet, or other suitable client device. In some examples, the client device 120 can receive the parameters 204 for each of the interaction channels 112a-b from a client via the user interface 200. The client device 122 can receive a parameter name 208 and a parameter value 210 to define data that can be retrieved by a multi-channel adapter 102 from interaction channels 112a-b. The client device 120 can further transmit the parameter name 208 and the parameter value 210 in a request to the multi-channel adapter 102.

For example, the user interface 200 can be used to set the parameters 204 for the first interaction channel 116a. Therefore, a first parameter 206a can be wire type codes that can indicate accounts receiving wire transfers for which the client device 120 can request data. Additionally, a second parameter 206b can be transaction type codes to specify transaction types for which the client device 120 can request data. As a result of the client device 120 receiving the parameters 204, the multi-channel adapter 102 can store the parameters 204 and can retrieve first data 108a from the first interaction channel 116a that satisfies the parameters 204. Additionally, the client device 122 can receive an adjustment the parameters 204 via the user interface 200, which can cause the multi-channel adapter 102 to update the stored parameters and can further cause the multi-channel adapter 102 to adjust a first API call 120a. The first API call 120a can be a request transmitted by the multi-channel adapter 102 to the first interaction channel 116a for the first data 108a.

Additional information or parameters can also be receive by the client device 120 via the user interface 200 and transmitted to the multi-channel adapter 102 for storage. For example, the user interface 200 can include Demand Deposit Account (DDA) threshold option 202. The client device 120 can receive an account threshold from a user via the DDA threshold option 202. The client device 120 can enable the user to provide a different account threshold via DDA threshold options for each of the interaction channels 112a-b. The DDA threshold option 202 can be used to transmit account thresholds to the multi-channel adapter that can prevent the multi-channel adapter from causing latency in the interaction channels 112a-b. The account thresholds can be a maximum amount of data the multi-channel adapter 102 can request per API call.

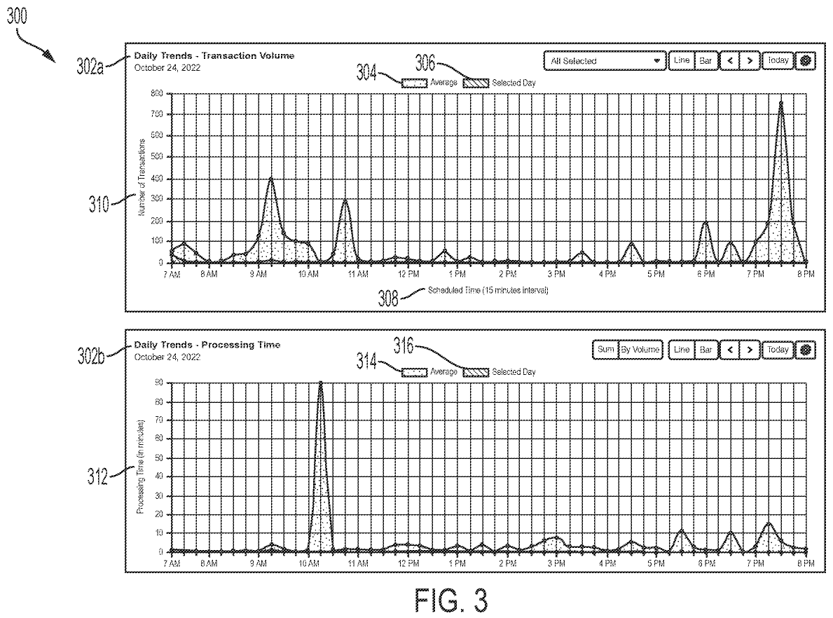

FIG. 3 is an example of a user interface 300 for facilitating transaction analysis using data retrieval thresholds according to one example of the present disclosure. Aspects of FIG. 3 are discussed in reference to the components shown in FIG. 1. The user interface 300 can be an example of a display of data caused by a multi-channel adapter 102 transmitting data 108a-b to a client device 120. The user interface 300 may include graphs 302a-b, tables, or other suitable displays of data organization to enable analysis of the data 108a-b. The user interface 300 can also be associated with the user interface of FIG. 2 such that the client device 120 can receive parameters, sets of accounts, etc. and can further provide the data 108a-b received from a multi-channel adapter 102 via the user interfaces. In some examples, the user interface 300 can be a first page that can be navigated to from a second page, such as the page shown in user interface 200 depicted in FIG. 2. A client may be able to toggle between the pages on a client device 120.

The user interface 300 can include a first graph 302a for analyzing transaction volume. The first graph 302a can show the number of transactions 310 over scheduled times 308. For example, the first graph 302a depicts the number of transactions 310 occurring every fifteen minutes. The first graph 302a can further include average transaction volumes 304 for comparison to selected day transaction volumes 306. In some examples, a difference between the average transaction volumes 304 and selected day transaction volumes 306 can exceed a transaction volume threshold. The transaction volume threshold may be provided by the client device 120 and can be based on historical data for transaction volume. In response to the difference exceeding the transaction volume threshold, the client device 120 can generate a first alert for display on the user interface 300 or another computing device.

Additionally, the user interface 300 can include a second graph 302b for analyzing processing times 312. The processing times 312 can be processing times for transactions to be received by a client account, for the multi-channel adapter 102 to retrieve data, or other suitable processing times. The second graph 302b can show the processing times 312 over scheduled times. The processing times 312 can be in minutes, seconds, or hours. The second graph 302b can further include average processing times 314 for comparison to selected day processing times 316. In some examples, a difference between the average processing times 314 and the selected day processing times 316 can exceed a processing time threshold. The processing time threshold can be set by the client device 120 and may be based on historical data indicative of processing times. For example, the average processing time associated with the multi-channel adapter 102 retrieving data for a transaction can be ten minutes. Therefore, the processing time threshold can be, as an example, twenty minutes. In response to the difference exceeding the processing time threshold, the client device 120 can generate a second alert for display on the user interface 300 or another computing device.

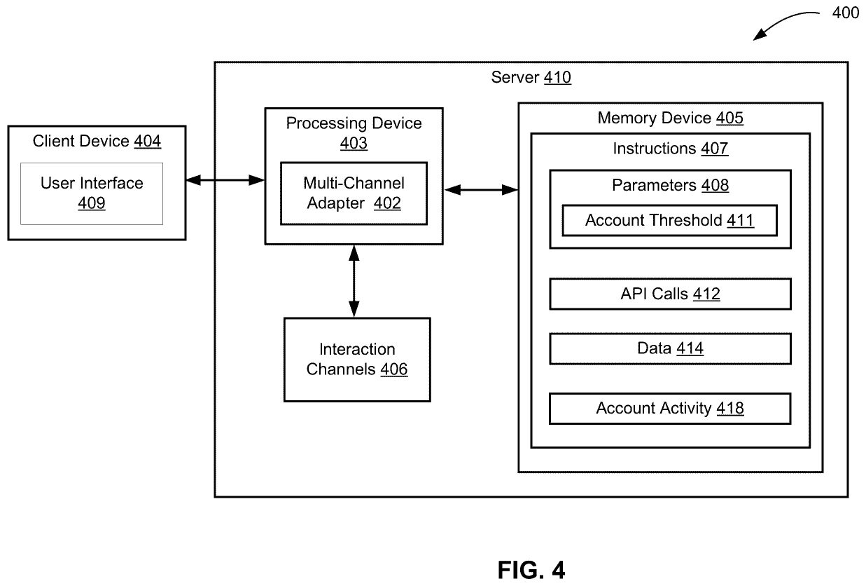

FIG. 4 is a block diagram of an example of a computing system 400 for facilitating transaction analysis for multiple entities according to one example of the present disclosure. The system 400 includes a processing device 403 that is communicatively coupled to a memory device 405. In some examples, the processing device 403 and the memory device 405 can be part of the same computing device, such as the server 410. In other examples, the processing device 403 and the memory device 405 can be distributed from (e.g., remote to) one another.

The processing device 403 can include one processor or multiple processors. Non-limiting examples of the processing device 403 include a Field-Programmable Gate Array (FPGA), an application-specific integrated circuit (ASIC), or a microprocessor. The processing device 403 can execute instructions 407 stored in the memory device 405 to perform operations. The instructions 407 may include processor-specific instructions generated by a compiler or an interpreter from code written in any suitable computer-programming language, such as C, C++, C#, Java, or Python.

The memory device 405 can include one memory or multiple memories. The memory device 405 can be volatile or non-volatile. Non-volatile memory includes any type of memory that retains stored information when powered off. Examples of the memory device 405 include electrically erasable and programmable read-only memory (EEPROM) or flash memory. At least some of the memory device 405 can include a non-transitory computer-readable medium from which the processing device 403 can read instructions 407. A non-transitory computer-readable medium can include electronic, optical, magnetic, or other storage devices capable of providing the processing device 403 with computer-readable instructions or other program code. Examples of a non-transitory computer-readable medium can include a magnetic disk, a memory chip, ROM, random-access memory (RAM), an ASIC, a configured processor, and optical storage.

The processing device 403 can execute the instructions 407 to perform operations. For example, the processing device 403 can receive, via a multi-channel adapter 402, parameters 408. The parameters 408 can include an account threshold 411, which can define a maximum number of accounts that can be included in a request. The processing device 403 can also execute, by the multi-channel adapter 402, API calls 412 associated with the request to interaction channels 406 based on the parameters 408. Additionally, the processing device 403 can receive, by the multi-channel adapter 402, data 414 that satisfies the parameters 408 in response to the API calls 412. The processing device 403 can further cause, via the multi-channel adapter 402, a display of the data 414 at a user interface 409 of a client device 404. The data 414 can be used by the client device 404 to analyze account activity 418.

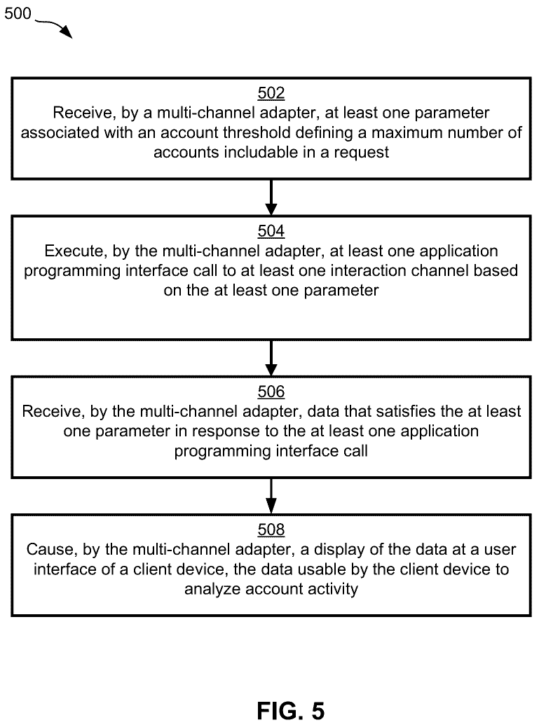

FIG. 5 is a flowchart of process for facilitating transaction analysis using data retrieval thresholds according to one example of the present disclosure. In some examples, the processing device 403 can implement some or all of the steps shown in FIG. 5. Other examples can include more steps, fewer steps, different steps, or a different order of the steps than is shown in FIG. 5. The steps of FIG. 5 are discussed below with reference to the components discussed above in relation to FIGS. 1 and 4.

At block 502 the processing device 403 can receive, by a multi-channel adapter 102, at least one parameter including an account threshold 106 defining a maximum number of accounts includable in a request. The account threshold 106 can be based on the maximum number of accounts for which the multi-channel adapter 102 can request data from an interaction channel without causing excessive latency for the interaction channel. In some examples, the multi-channel adapter 102 can receive the parameters 104, such as the account threshold 106, from interaction channels 112a-b. Receiving the parameters 104 from the interaction channels 112a-b can enable the interaction channels 112a-b to directly communicate the account thresholds 106 that can maintain or improve processing speed of data 108a-b to the multi-channel adapter 102. In other examples, the parameters 104 can be received by the multi-channel adapter 102 from the client device 120. Additionally, the parameters 104 can include an indication of a type of data to be requested from interaction channels 112a-b. For example, the parameters 104 can indicate types of wire transfers requested by the client device 120 from a first interaction channel 112a and can indicate types of ACH transactions requested by the client device 120 from a second interaction channel 112b.

At block 504 the processing device 403 can execute, by the multi-channel adapter 102, at least one API call 116a-b associated with the request to at least one interaction channel based on the at least one parameter. The API calls 116a-b can be unique for each of the interaction channels 112a-b. For example, a first API call 116a associated with the first interaction channel 112a can be different than a second API call 116b associated with the second interaction channel 112b. Additionally, the multi-channel adapter 102 may receive an adjustment to the parameters 104. For example, the client device can transmit an increase in an account threshold for the first interaction channel 112a. In response, the multi-channel adapter 102 may adjust the first API call 116. The adjustment to the first API call 116a can cause an adjustment to first data 108a retrieved from the first interaction channel 112a that reflects the increase in the account threshold.

In some examples, the multi-channel adapter 102 may determine that the number of accounts associated with the request to an interaction channel for data exceeds the account threshold 106 for the interaction channel. Therefore, the multi-channel adapter 102 can generating a first request for a first subset of accounts and a second request for a second subset of accounts. The first subset of accounts and the second subset of accounts can both be below the account threshold. The multi-channel adapter 102 can further execute a first API call for the first request to the interaction channel for the first subset of accounts and can execute a second API call for the second request to the interaction channel for the second subset of accounts.

At block 506 the processing device 403 can receive, by the multi-channel adapter 102, data that satisfies the at least one parameter in response to the at least one API call 112a-b. In the example above, the multi-channel adapter 102 may receive first data for the first subset of accounts in response to the first API call. Then, subsequent to receiving the first data, the multi-channel adapter 102 may execute the second API call to receive second data for the second subset of accounts.

At block 508 the processing device 403 can cause, by the multi-channel adapter 102, a display of the data 108a-b at a user interface 123 of the client device 120. The data 108a-b can be usable by the client device 120 to analyze account activity 124. The data 108a-b can be displayed as graphs, tables, or the like to enable analysis of the account activity 124 at the client device 120. The data 108a-b may be compared to historical data or otherwise analyzed. Additionally, the client device 120 can generate a prediction of upcoming account activity based on the data 108a-b. For example, the interaction channels can be transaction channels and the data 108a-b can be associated with transactions initiated to accounts 110a-b. Therefore, the client device 120 can generate a prediction of account balances for the next business day based on the data 108a-b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
receiving, by a multi-channel adapter, at least one parameter including an account threshold defining a maximum number of accounts includable in a request;
executing, by the multi-channel adapter, at least one application programming interface call associated with the request to at least one interaction channel based on the at least one parameter;
receiving, by the multi-channel adapter, data that satisfies the at least one parameter in response to the at least one application programming interface call; and
causing, by the multi-channel adapter, a display of the data at a user interface of a client device, the data usable by the client device to analyze account activity.

2. The system of claim 1, wherein the memory device further includes instructions executable by the processing device for causing the processing device to receive, by the multi-channel adapter, the data that satisfies the at least one parameter by:
determining a number of accounts associated with the request exceeds the account threshold;
generating a first request for a first subset of accounts and a second request for a second subset of accounts, wherein the first subset of accounts and the second subset of accounts are each below the account threshold;
executing, by the multi-channel adapter, a first application programming interface call for the first request to the at least one interaction channel for the first subset of accounts; and
executing, by the multi-channel adapter, a second application programming interface call for the second request to the at least one interaction channel for the second subset of accounts.

3. The system of claim 2, further comprising:
receiving, by the multi-channel adapter, first data in response to the first application programming interface call; and
subsequent to receiving the first data, executing, by the multi-channel adapter, the second application programming interface call.

4. The system of claim 1, wherein the memory device further includes instructions executable by the processing device for causing the processing device to receive, by the multi-channel adapter, the data that satisfies the at least one parameter by:
receiving, by the multi-channel adapter, the at least one parameter including the account threshold from the at least one interaction channel.

5. The system of claim 1, wherein a first application programming interface call of the at least one application programming interface call associated with a first interaction channel of the at least one interaction channel is different than a second application programming interface call of the at least one application programming interface call associated with a second interaction channel of the at least one interaction channel.

6. The system of claim 1, wherein the memory device further includes instructions executable by the processing device for causing the processing device to:
receive, by the multi-channel adapter, an adjustment to the at least one parameter; and
adjust, by the multi-channel adapter, the at least one application programming interface call to cause a modification to the data retrieved from the at least one interaction channel.

7. The system of claim 1, wherein the at least one parameter further comprises an indication of a type of data to be requested from each interaction channel of the at least one interaction channel.

8. The system of claim 1, wherein the client device is configured to generate a prediction of upcoming account activity.

9. A computer-implemented method comprising:
receiving, by a multi-channel adapter, at least one parameter including an account threshold defining a maximum number of accounts includable in a request;
executing, by the multi-channel adapter, at least one application programming interface call associated with the request to at least one interaction channel based on the at least one parameter;
receiving, by the multi-channel adapter, data that satisfies the at least one parameter in response to the at least one application programming interface call; and
causing, by the multi-channel adapter, a display of the data at a user interface of a client device, the data usable by the client device to analyze account activity.

10. The computer-implemented method of claim 9, further comprising:
determining a number of accounts associated with the request exceeds the account threshold;
generating a first request for a first subset of accounts and a second request for a second subset of accounts, wherein the first subset of accounts and the second subset of accounts are each below the account threshold;
executing, by the multi-channel adapter, a first application programming interface call for the first request to the at least one interaction channel for the first subset of accounts; and
executing, by the multi-channel adapter, a second application programming interface call for the second request to the at least one interaction channel for the second subset of accounts.

11. The computer-implemented method of claim 10, further comprising:
receiving, by the multi-channel adapter, first data in response to the first application programming interface call; and
subsequent to receiving the first data, executing, by the multi-channel adapter, the second application programming interface call.

12. The computer-implemented method of claim 9, wherein receiving, by the multi-channel adapter, the data that satisfies the at least one parameter further comprises:
receiving, by the multi-channel adapter, the at least one parameter including the account threshold from the at least one interaction channel.

13. The computer-implemented method of claim 9, wherein a first application programming interface call of the at least one application programming interface call associated with a first interaction channel of the at least one interaction channel is different than a second application programming interface call of the at least one application programming interface call associated with a second interaction channel of the at least one interaction channel.

14. The computer-implemented method of claim 9, further comprising:
receiving, by the multi-channel adapter, an adjustment to the at least one parameter; and
adjusting, by the multi-channel adapter, the at least one application programming interface call to cause a modification to the data retrieved from the at least one interaction channel.

15. The computer-implemented method of claim 9, wherein the at least one parameter further comprises an indication of a type of data to be requested from each interaction channel of the at least one interaction channel.

16. A non-transitory computer-readable medium comprising instructions that are executable by a processing device for causing the processing device to perform operations comprising:
receiving, by a multi-channel adapter, at least one parameter including an account threshold defining a maximum number of accounts includable in a request;
executing, by the multi-channel adapter, at least one application programming interface call associated with the request to at least one interaction channel based on the at least one parameter;
receiving, by the multi-channel adapter, data that satisfies the at least one parameter in response to the at least one application programming interface call; and
causing, by the multi-channel adapter, a display of the data at a user interface of a client device, the data usable by the client device to analyze account activity.

17. The non-transitory computer-readable medium of claim 16, further comprising instructions executable by the processing device for causing the processing device to receive, by the multi-channel adapter, the data that satisfies the at least one parameter by:
determining a number of accounts associated with the request exceeds the account threshold;
generating a first request for a first subset of accounts and a second request for a second subset of accounts, wherein the first subset of accounts and the second subset of accounts are each below the account threshold;
executing, by the multi-channel adapter, a first application programming interface call for the first request to the at least one interaction channel for the first subset of accounts; and
executing, by the multi-channel adapter, a second application programming interface call for the second request to the at least one interaction channel for the second subset of accounts.

18. The non-transitory computer-readable medium of claim 17, further comprising:
receiving, by the multi-channel adapter, first data in response to the first application programming interface call; and
subsequent to receiving the first data, executing, by the multi-channel adapter, the second application programming interface call.

19. The non-transitory computer-readable medium of claim 16, further comprising instructions executable by the processing device for causing the processing device to receive, by the multi-channel adapter, the data that satisfies the at least one parameter by:
receiving, by the multi-channel adapter, the at least one parameter including the account threshold from the at least one interaction channel.

20. The non-transitory computer-readable medium of claim 16, wherein a first application programming interface call of the at least one application programming interface call associated with a first interaction channel of the at least one interaction channel is different than a second application programming interface call of the at least one application programming interface call associated with a second interaction channel of the at least one interaction channel.
